(19) United States
(12) Patent Application Publication
(10) Pub. No.: US 2026/0275160 A1
(43) Pub. Date: Sep. 17, 2026

(54) CMP SLURRY REUSE OPTIMIZATION SYSTEM THROUGH CONVERGENCE AND COMPLEX PROCESSING TECHNOLOGY

(71) Applicant: SK hynix Inc., Icheon-si Gyeonggi-do (KR)

(72) Inventors: Kwan-ho Lee, Icheon-si Gyeonggi-do (KR); Soung-hi Bae, Icheon-si Gyeonggi-do (KR); Gab-sung Kim, Icheon-si Gyeonggi-do (KR)

(73) Assignee: SK hynix Inc., Icheon-si Gyeonggi-do (KR)

(21) Appl. No.: 19/300,321

(22) Filed: Aug. 14, 2025

(30) Foreign Application Priority Data
Mar. 12, 2025 (KR) 10-2025-0031809

(51) Int. Cl. C09G 1/02; B01D 36/02; B01D 43/00; B01D 61/14; B01D 61/16; B01D 61/18; B01D 61/58; B03C 5/02; B01D 61/02; B01D 61/08

(52) U.S. Cl. CPC C09G 1/02; B01D 36/02; B01D 43/00; B01D 61/145; B01D 61/16; B01D 61/18; B01D 61/58; B03C 5/02; B01D 61/025; B01D 61/08

(57) ABSTRACT

A slurry reuse system includes a slurry collection part that selectively collects high-concentration waste slurry included in waste slurry discharged after a CMP process, a fine particle separation part that separates fine particles by applying high-frequency sound waves to abrasive particles of the collected high-concentration waste slurry, an abrasive particle uniformity part that operates simultaneously with the fine particle separation part and that has electrodes inserted into both ends of the waste slurry, secures the uniformity of the shape and size of the abrasive particles, and removes impurities by applying an electric field, a slurry mixing part that mixes slurry subjected to processes of the fine particle separation part and the abrasive particle uniformity part, a filter part that extracts abrasive particles, chemicals, and DI water from the mixed slurry, and an abrasive particle and chemical remixing part that re-mixes the extracted abrasive particles and high-concentration chemicals.

### CROSS-REFERENCE TO RELATED APPLICATION

The present application claims priority under 35 U.S.C. §119(a) to Korean Patent Application No. 10-2025-0031809, filed in the Korean Intellectual Property Office on Mar. 12, 2025, the entire contents of which application is incorporated herein by reference.

### BACKGROUND

### 1. Technical Field

Embodiments relate to a system for regenerating and reusing slurry abrasives in a chemical mechanical polishing (CMP) device, and more particularly, to an advancement technology in which specific particles are selectively recovered from waste slurry that is discharged in large quantities and a contaminant is removed after a CMP process of forming an insulating layer and/or a metal line that is planarized by making slurry flow on a surface of a wafer in order to form a fine semiconductor circuit.

### 2. Related Art

In general, a method of treating waste slurry that is generated in a CMP process includes a purification treatment method using a water treatment drug, a method of solidifying and treating waste slurry, and a method of regenerating and treating valid abrasive particles or chemical substances within slurry by purifying the valid abrasive particles or chemical substances.

The proposed purification treatment method using a water treatment drug includes removing contaminants through proper drug treatment using slaked lime (Ca(OH)2), a sulfuric acid (H2SO4), or polymer (coagulant aids), performing dilution using de-ionized (DI) water, and then discharging treated matters to a river according to a legal discharge standard, but has problems in that diluted waste water is increased due to the use of a large amount of DI water in such a drug treatment process and costs are increased due to the expansion of an additional waste water storage and treatment facility.

Furthermore, the solidification treatment of waste slurry may have a great influence on an ecosystem if a solid object includes particles, such as silica (SiO2) and alumina, and toxic substances, such as heavy metals, and has a problem in that health and health risks of a worker may be caused due to chemical components.

In order to solve a treatment cost problem and an environmental problem attributable to the waste water treatment of the waste slurry, a regeneration treatment method of obtaining DI water slurry by removing contaminants within waste slurry that is generated after a CMP process may be used.

In order to purify valid abrasive particles or chemicals within the waste slurry and use the valid abrasive particles in a process again, various conventional techniques for removing contaminants through a purification process are presented.

A regeneration slurry system according to a conventional technology has disadvantages in that contaminants are excessively introduced in a technique for collecting waste slurry it is necessary to collect the contaminants and secure a water tank space, and additional causes, such as waste water treatment time and costs, are caused.

Furthermore, waste slurry may include various contaminants due to its nature. The contaminants may affect a process if the contaminants are not removed. In a current technique for separating fine particles within waste slurry, a technique for separating fine abrasive particles and contaminants by a shaker has a disadvantage in that treatment efficiency is degraded due to its technical limit because the technique merely reaches a level in which a suspended material is removed by simple precipitation and sedimentation.

Furthermore, the technique has a disadvantage in that a market demand is low due to resistance against a product, which results from the insufficient market recognition and lack of trust in the quality of regenerated slurry because the recognition of a market for regenerated slurry and trust in quality are insufficient.

### Prior Art Document

### Patent Document

(Patent Document 0001) Korean Patent No. 10-1078818 (Oct. 26, 2011)

(Patent Document 0002) Korean Patent Application Publication No. 10-2023-0001382 (Jan. 4, 2023)

(Patent Document 0003) U.S. Patent No. 8387902 B2 (Mar. 5, 2013)

### SUMMARY

In an embodiment, a CMP slurry reuse system includes a slurry collection part configured to selectively collect high-concentration waste slurry included in waste slurry that is discharged after a chemical mechanical polishing (CMP) process, a fine particle separation part configured to separate fine particles by applying high-frequency sound waves to abrasive particles of the high-concentration waste slurry collected by the slurry collection part, an abrasive particle uniformity part configured to operate simultaneously with the fine particle separation part and to have electrodes inserted into both ends of the waste slurry so that only uniform particles are able to be decomposed by an electrochemical reaction and to secure the uniformity of the shape and size of the abrasive particles and remove impurities by applying an electric field, a slurry mixing part configured to mix slurry on which processes of the fine particle separation part and the abrasive particle uniformity part have been performed, a filter part configured to extract abrasive particles, chemicals, and DI water from the slurry mixed by the slurry mixing part, and an abrasive particle and chemical remixing part configured to re-mix the abrasive particles and high-concentration chemicals extracted by the filter part.

The CMP slurry reuse system according to an embodiment of the present disclosure has effects in that it can reduce sludge and waste water that are used in a production process and reduce chemicals that are used when exhausts or waste water which may occur when slurry is transported are treated, by reusing a chemical raw material and DI water.

Furthermore, reuse slurry can be used without a precipitation phenomenon because the reuse slurry is directly supplied to a production process without a designated space and a transporting distance. Abrasive particles and chemicals within impurities can be obtained, and DI water can be extracted from a mixture of the abrasive particles and the chemicals and reused.

### BRIEF DESCRIPTION OF THE DRAWINGS

FIG. 1 is a diagram that represents a progress process of a CMP slurry regeneration system according to an embodiment of the present disclosure.

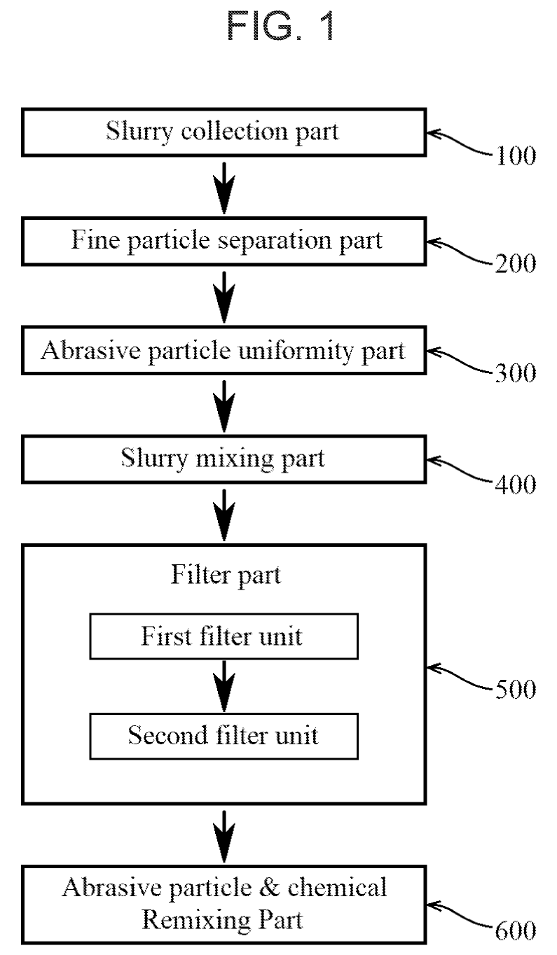

FIG. 2 is a diagram that represents a slurry collection part in a progress process of the CMP slurry regeneration system according to an embodiment of the present disclosure.

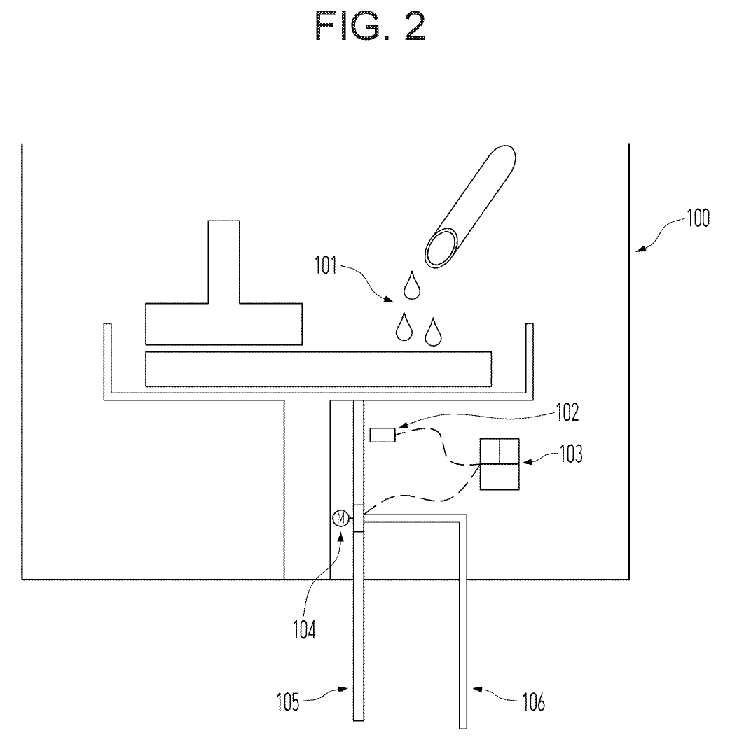

FIG. 3 is a diagram that represents a fine particle separation part, an abrasive particle uniformity part, and a slurry mixing part in a progress process of the CMP slurry regeneration system according to an embodiment of the present disclosure.

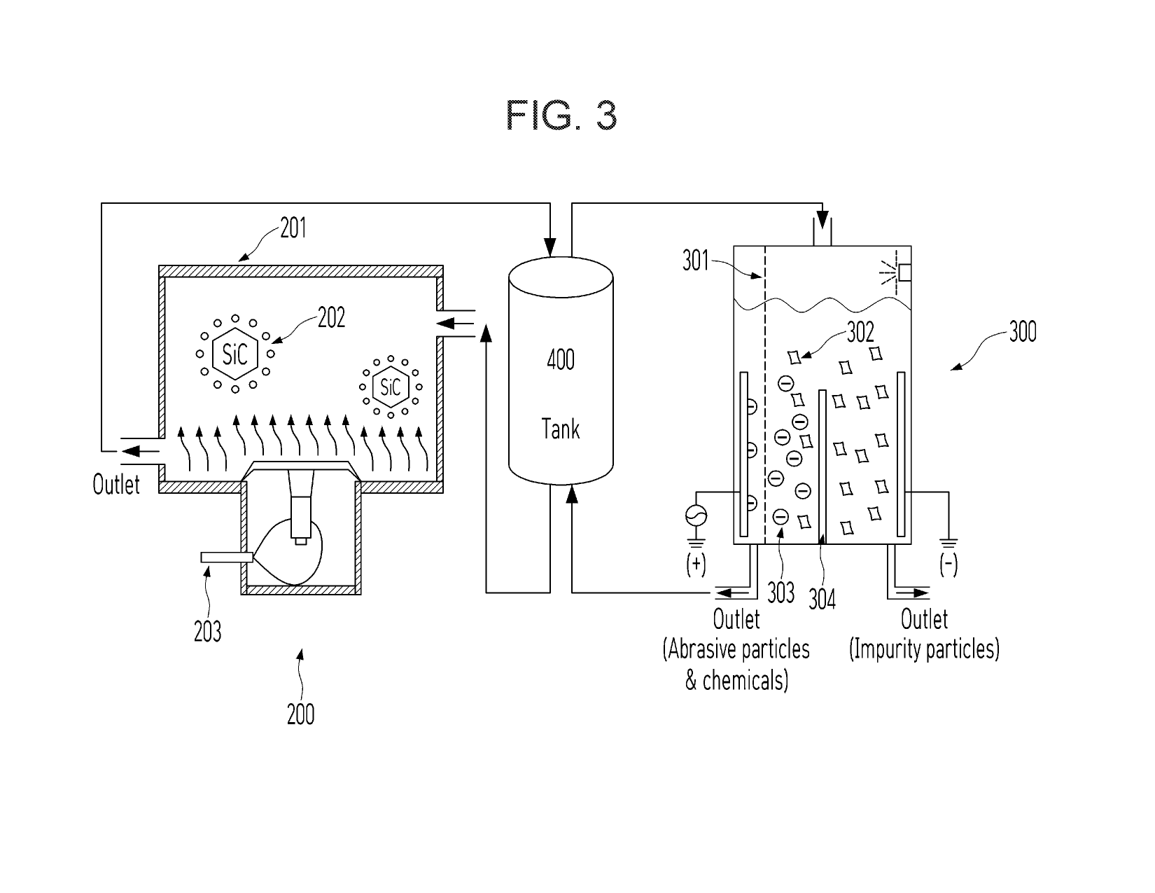

FIG. 4 is a diagram that represents a filter part in a progress process of the CMP slurry regeneration system according to an embodiment of the present disclosure.

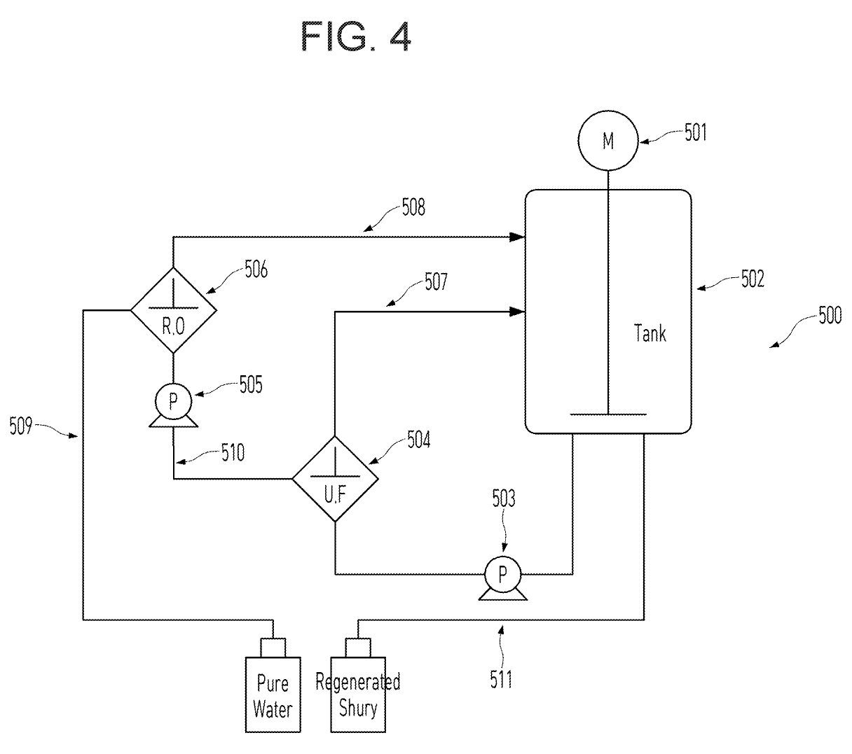

FIG. 5 is a diagram that represents abrasive particles and a chemical remixing part in a progress process of the CMP slurry regeneration system according to an embodiment of the present disclosure.

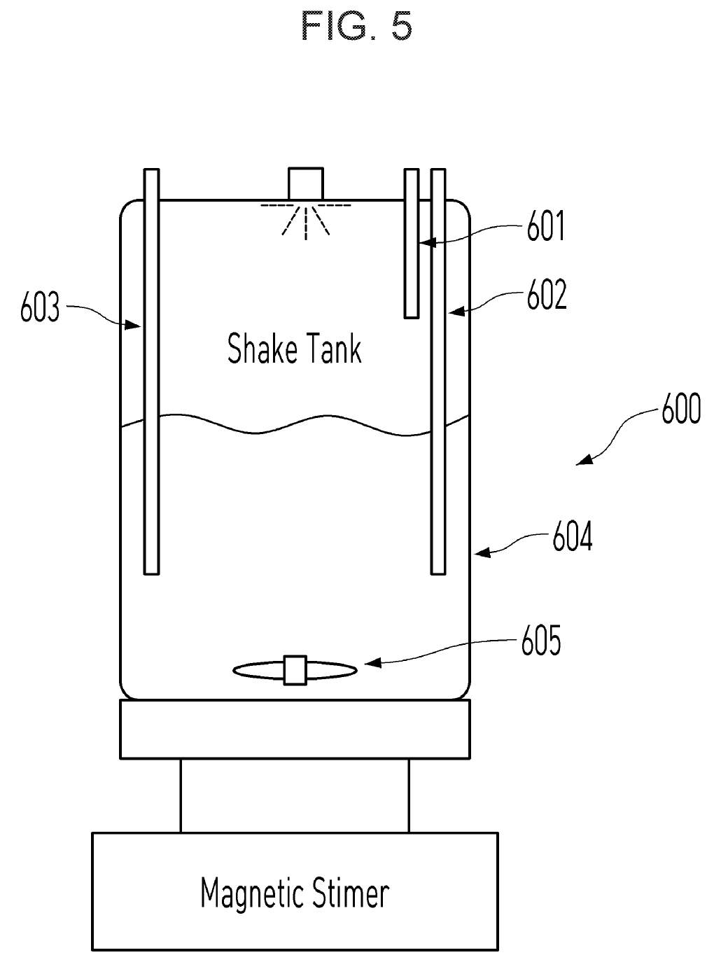

### DETAILED DESCRIPTION

Hereinafter, embodiments according to the technical spirit of the present disclosure are described with reference to the accompanying drawings.

Various embodiments are directed to providing a CMP slurry reuse optimization system through a convergence and complex processing technology.

That is, various embodiments are directed to providing a CMP slurry reuse system by developing an advancement technology in which specific particles within waste slurry are selectively recovered and contaminants are removed.

The present disclosure may be changed in various ways and may have various embodiments. Aspects (or embodiments) are described in the specification in detail. It is however to be understood that the present disclosure is not intended to be limited to the specific disclosure and that the present disclosure includes all changes, equivalents and substitutions which fall within the spirit and technical scope of the present disclosure.

Terms used in this specification are used to only describe specific aspects (or embodiments) and are not intended to restrict the present disclosure. An expression of the singular number includes an expression of the plural number unless clearly defined otherwise in the context. In this specification, a term, such as “include (or comprise)” or “have”, is intended to designate the presence of a characteristic, a number, a step, an operation, a component, a part or a combination of them described in the specification, and should be understood that it does not exclude the possible existence or addition of one or more other characteristics, numbers, steps, operations, components, parts, or combinations of them in advance.

All terms used herein, including technical terms or scientific terms, have the same meanings as those commonly understood by a person having ordinary knowledge in the art to which the present disclosure pertains, unless defined otherwise in the specification. Terms, such as those commonly used and defined in dictionaries, should be construed as having the same meanings as those in the context of a related technology, and are not construed as having ideal or excessively formal meanings unless explicitly defined otherwise in the specification.

Terms, such as “a first ~” and “a second ~” described in the specification, are used to merely distinguish between different components, and are not restricted by a fabricated sequence. The names of components may not be the same in the detailed description and claims of the present disclosure.

A chemical mechanical polishing (CMP) process is a semiconductor miniaturization process of forming an insulating layer and/or a metal line planarized by making CMP slurry into a surface of a wafer in order to form a fine semiconductor circuit.

The slurry that is made to flow on the surface of the wafer includes abrasives and de-ionized (DI) water in order to planarize the wafer, and includes additives, such as dispersants, oxidants, PH control fluids, and corrosion inhibitors in order to stabilize particles depending on the type of semiconductor film.

The abrasives are abrasive particles that perform grinding work in order to remove a membrane material, and need to maintain dispersibility and the amount of grinding and to have proper hardness so that a scratch on a surface of a wafer is minimize.

The DI water serves to carry abrasives, functions as a lubricant so that a scratch attributable to abrasives does not occur, and functions to move residues generated in a CMP process and to adjust heat that is generated while grinding is performed.

The additives serve to add a function that is additionally required depending on the characteristics of a material that is grinded while amplifying a slurry effect, and representatively includes an antifoaming agent (the suppression of air bubbles), a corrosion inhibitor, and a PH control solution.

A slurry reuse optimization system according to an embodiment of the present disclosure includes a slurry collection part 100 configured to selectively collect high-concentration waste slurry included in waste slurry that is discharged after a chemical mechanical polishing (CMP) process, a fine particle separation part 200 configured to separate fine particles by applying high-frequency sound waves to abrasive particles of the high-concentration waste slurry collected by the slurry collection part 100, an abrasive particle uniformity part 300 configured to operate simultaneously with the fine particle separation part 200 and to have electrodes inserted into both ends of the waste slurry so that only uniform particles are able to be decomposed by an electrochemical reaction and to secure the uniformity of the shape and size of the abrasive particles and remove impurities by applying an electric field, a slurry mixing part 400 configured to mix slurry on which processes of the fine particle separation part 200 and the abrasive particle uniformity part 300 have been performed, a filter part 500 configured to extract abrasive particles, chemicals, and DI water from the slurry mixed by the slurry mixing part 400, and an abrasive particle and chemical remixing part 600 configured to re-mix the abrasive particles and high-concentration chemicals extracted by the filter part 500.

First, the slurry collection part 100 measures a concentration of abrasive particles and a concentration of chemicals within waste slurry that is discharged after a CMP process in real time through a specific gravity meter 102.

The specific gravity meter 102 is a device for measuring a concentration of abrasive particles and a concentration of chemicals within waste slurry in real time. A measured gravity value is transmitted to a 3-way control valve 104 and an automatic opening/closing control device 103.

When the concentration of the abrasive particles and the concentration of the chemicals within the waste slurry, which are measured by the specific gravity meter 102, are low, the 3-way control valve 104 is connected to the waste water treatment path 105. When the concentration of the abrasive particles and the concentration of the chemicals are high, the 3-way control valve 104 is connected to a reuse path 106.

Furthermore, the automatic opening/closing control device 103 automatically controls the specific gravity meter 102 and the 3-way control valve 104 in real time by making the specific gravity meter 102 and the 3-way control valve 104 operate in conjunction with each other in order to embody automatic control system monitoring so that waste slurry can be selectively collected.

The fine particle separation part 200 applies high-frequency sound waves to high-concentration waste slurry collected by the slurry collection part 100 through an ultrasonic generator 203.

The high-concentration waste slurry collected by the slurry collection part 100 includes various impurities and contaminants along with a large amount of abrasive particles.

If the various impurities and contaminants included in the high-concentration waste slurry are not removed, scratches may occur on a surface of a wafer, which can directly affect the quality of a semiconductor and lead to a reduction in the production yield.

Fine particles 202, that is, contaminants attached to surfaces of the abrasive particles, are distributed by applying high-frequency sound waves to the abrasive particles within the waste slurry through the ultrasonic generator 203 in order to prevent cohesion.

The fine particle separation part 200 prevents cohesion by distributing the fine particles 202, that is, contaminants attached to the surfaces of the abrasive particles within the waste slurry. The abrasive particle uniformity part 300 uniformly secures the abrasive particles without a change in shape, such as the size and shape of the abrasive particles, by separating the abrasive particles and the contaminants or impurities through a mesh filter 301, an internal separation film 304, and an electric field.

The abrasive particle uniformity part 300 has electrodes inserted into both ends of the waste slurry and applies an electric field to the electrodes so that the abrasive particles and the contaminants are moved to different poles.

In general, abrasive particles that are used in a CMP process have negative charges (-) and are moved to a positive pole when an electric field is applied to the abrasive particles. Contaminant that are generated in a CMP process have positive charges (-) and are moved to a minus pole.

The mesh filter 301 functions to filter out impurities while maintaining the size and shape of abrasive particles so that the abrasive particles can be uniformly maintained.

The internal separation film 304 is a core element that improves separation efficiency of particles within an electric field, and forms a boundary so that particles having different polarities can be clearly separated when an electric field is applied to the particles. Accordingly, the abrasive particles and the contaminants can be separated more finely.

Thereafter, the slurry mixing part 400 mixes slurry on which processes of the fine particle separation part 200 and the abrasive particle uniformity part 300 have been performed.

The filter part 500 includes a first filter part including an ultrafiltration membrane 504 and an ultrafiltration pump 503 and a second filter part including a reverse osmosis membrane 506 and a reverse osmosis pump 505.

The ultrafiltration pump 503 functions to pass the waste slurry through the ultrafiltration membrane 504 with constant pressure so that fine particles within the waste slurry can be effectively filtered.

The ultrafiltration membrane 504 is a filter capable of filtering fine particles each having a size of 0.01 to 0.1 μm, and primarily separates abrasive particles, chemicals, and DI water.

The reverse osmosis pump 505 is a device that passes the waste slurry through the reverse osmosis membrane 506 by applying high pressure, and moves chemicals and DI water separated by the first filter part to the reverse osmosis membrane 506.

The reverse osmosis membrane 506 is an ultrafine filter having a size of 0.0001 to 0.001 μm, and extracts high-concentration chemicals and DI water by separating the high-concentration chemicals and the DI water.

The extracted high-concentration chemicals form regeneration slurry by being mixed with the abrasive particles extracted by the first filter part. The extracted DI water is used as reused water.

The abrasive particles and chemicals mixing part 600 manufactures slurry which may be reused in a CMP process by inputting and shaking regeneration slurry 602 in which the abrasive particles extracted by the first filter part and the high-concentration chemicals extracted by the second filter part are mixed, new chemicals 601 for maintaining an optimal chemical composition of the slurry, and a slurry system 603 that adjusts the viscosity, pH, and particle distribution of the slurry.

The method according to the present disclosure may be divided into additional steps or steps may be combined into smaller steps depending on an implementation example of the present disclosure. Furthermore, some steps may be omitted if necessary, and the sequence of the steps may be changed.

The present disclosure described above with reference to the accompanying drawings may be modified and changed in various ways by those skilled in the art. Such modifications and changes that are not limited through the claims should be interpreted as being included in the scope of a right of the present disclosure.

What is claimed is:

1. A slurry reuse system through a convergence and complex processing technology:
a slurry collection part configured to selectively collect high-concentration waste slurry included in waste slurry that is discharged after a chemical mechanical polishing (CMP) process;
a fine particle separation part configured to separate fine particles by applying high-frequency sound waves to abrasive particles of the high-concentration waste slurry collected by the slurry collection part;
an abrasive particle uniformity part configured to operate simultaneously with the fine particle separation part and to have electrodes inserted into both ends of the waste slurry so that only uniform particles are able to be decomposed by an electrochemical reaction and to secure uniformity of a shape and size of the abrasive particles and remove impurities by applying an electric field;
a slurry mixing part configured to mix slurry on which processes of the fine particle separation part and the abrasive particle uniformity part have been performed;
a filter part configured to extract abrasive particles, chemicals, and DI water from the slurry mixed by the slurry mixing part; and
an abrasive particle and chemical remixing part configured to re-mix the abrasive particles and high-concentration chemicals extracted by the filter part.

2. The slurry reuse system of claim 1, wherein the slurry collection part comprises a specific gravity meter configured to measure gravity of the waste slurry.

3. The slurry reuse system of claim 2, wherein the slurry collection part comprises a 3-way control valve configured to divide the waste slurry into a waste water treatment path and a reuse path 106 by receiving a signal of the specific gravity meter.

4. The slurry reuse system of claim 3, wherein the slurry collection part comprises an automatic opening/closing control device capable of automatically controlling the specific gravity meter and the 3-way control valve in real time by making the specific gravity meter and the 3-way control valve operate in conjunction with each other so that automatic control system monitoring is embodied.

5. The slurry reuse system of claim 3, wherein:
low-concentration slurry comprising abrasive particles in small quantities is discharged from the waste water treatment path, and
high-concentration slurry comprising abrasive particles in large quantities is discharged from the reuse path.

6. The slurry reuse system of claim 1, wherein the fine particle separation part comprises an ultrasonic generator configured to generate high-frequency sound waves.

7. The slurry reuse system of claim 1, wherein the abrasive particle uniformity part comprises a mesh filter configured to filter out impurities while uniformly maintaining a size and shape of the abrasive particles.

8. The slurry reuse system of claim 7, wherein the abrasive particle uniformity part further comprises an internal separation film configured to improve separation efficiency of particles within an electric field.

9. The slurry reuse system of claim 1, wherein the filter part comprises a first filter part comprising an ultrafiltration pump and an ultrafiltration membrane.

10. The slurry reuse system of claim 9, wherein the filter part further comprises a second filter part comprising a reverse osmosis pump and a reverse osmosis membrane.

11. The slurry reuse system of claim 9, wherein the first filter part extracts abrasive particles and chemicals by filtering slurry extracted by the abrasive particle uniformity part through the ultrafiltration membrane.

12. The slurry reuse system of claim 10, wherein the first filter part extracts abrasive particles and chemicals by filtering slurry extracted by the abrasive particle uniformity part through an ultrafiltration membrane.

13. The slurry reuse system of claim 10, wherein the second filter part extracts high-concentration chemicals and DI water by re-filtering chemicals extracted by the first filter part through a reverse osmosis membrane.

14. The slurry reuse system of claim 10, wherein abrasive particles extracted by the first filter part and high-concentration chemicals extracted by the second filter part are mixed to form regeneration slurry.

15. The slurry reuse system of claim 10, wherein the abrasive particle and chemical remixing part re-adjusts a chemical composition ratio by inputting regeneration slurry produced by mixing abrasive particles extracted by the first filter part and high-concentration chemicals extracted by the second filter part, new chemicals, and a slurry system.
